(19) United States
(12) Patent Application Publication
(10) Pub. No.: US 2023/0315787 A1
(43) Pub. Date: Oct. 5, 2023

(54) Evolutionary Analysis of an Identity Graph Data Structure

(71) Applicant: LiveRamp, Inc., San Francisco, CA (US)

(72) Inventors: W. Dwayne Collins, Conway, AR (US); Pavan Roy Marupally, Conway, AR (US)

(21) Appl. No.: 18/020,900

(22) PCT Filed: Aug. 11, 2021
(86) PCT No.: PCT/US2021/045580

§ 371 Date: Feb. 10, 2023

Related U.S. Application Data
(60) Provisional application No. 63/070,911, filed on Aug. 27, 2020.

(51) Int. Cl. G06F 16/901

(52) U.S. Cl. CPC G06F 16/9027

(57) ABSTRACT

An environment measures the value of data sources as input to an identity graph in terms of the impact of the inclusion or removal of the data sources. Combinations of candidate sources are delivered to a sandbox environment to generate the desired output. A person process, a person plus touchpoint process, and an activity value process are executed. Results include whether a person was added or removed; whether a person created a point of failure; and whether persons were consolidated or a person was split. The output provides an analysis of the evolution of an identity graph within an entity resolution system based on the choice of data sets used to build the graph.

### CROSS-REFERENCE TO RELATED APPLICATIONS

This application claims the benefit of U.S. provisional patent application No. 63/070,911, entitled “System and Method for Evolutionary Analysis of Identity Graph,” filed on Aug. 27, 2020. Such application is incorporated herein by reference in its entirety.

### BACKGROUND

Entity resolution systems are used to determine whether data pertaining to real-world entities actually refer to the same or entity or different entities. They may be used, for example, to determine if different items of data pertaining to persons actually pertain to the same real-world person. Entity resolutions systems of this this type must overcome many complications, such as persons who use different names or nicknames in different contexts, changes of name or address, different persons with the same name, and the like. Entity resolution systems often use identity graphs in order to keep track of data pertaining to entities. An identity graph (or, more generally, a data graph) is a data structure that links together data that pertains to the same entity. For example, an identity graph may be formed of a set of nodes each comprising an item of data about an entity with edges that connect those nodes together if the nodes pertain to the same entity. Data sources of various types may be used to build and maintain identity graphs. Because available data sources about a universe of entities may change over time, new data sources may become available, or old data sources may no longer be available, identity graphs may be periodically or even continuously updated. The accuracy of the entity resolution system is directly dependent upon the accuracy of the identity graph used to support the system, and thus data sources used to build and maintain the identity graph must be selected carefully.

The impact of a set of data sources on the evolutionary enhancement of an identity graph within an entity resolution system may change through the lifetime of the system. In an entity resolution system pertaining to persons, the data sources that once were valuable in terms of unique coverage of personally identifiable information (PII) that assert to define persons may no longer provide such information as specific PII gets proliferated through many different data sources. Similarly, the quality of the PII can deteriorate over time due to intentional or unintentional obfuscation, abbreviation, or transcription errors with respect to the specific PII. To both manage the costs associated with the data sources ingested into the system and maintain a continued level of quality in the system, the existing data sources should be re-evaluated on a regular basis. Also, in the event that a set of existing data sources is required to be removed due to contractual or other circumstances, it may be advantageous to determine whether the loss of this set of sources must be mitigated in order to preserve the quality of the system and, if so, what aspects of the identity graph requires mitigation.

The situations described above may require an in-depth analysis of the sequence of changes to the data graph relative to the data sources involved as well as other associated sources. For example, if a candidate data source is intended as an eventual replacement for one or more existing sources, it may be advantageous to first determine what impact the removal of the existing sources may have on the identity graph. This requires starting with the existing graph, then removing all of the sources that are expected to be replaced. Then the candidate source is added to this last version and the impact of the addition of the new source is evaluated. Finally, the original data graph is compared with the fully altered graph to determine overall differences.

As the data graphs forming the basis of business entity resolution systems are quite large, contains tens to hundreds of billions of records and hundreds of millions to billions of persons, such an evaluation like the example above using the full identity graph in a manual comparison process would require such large computing resources that a full contextual evaluation of the computed results would not be feasible. In addition, given the enormous number of potential data sources and the constantly changing nature of these data sources, performing a manual process as described above to evaluate the various choices is no longer practicable. Therefore, a system and method to perform this function in an automated fashion while also operating in a computationally feasible framework within a business meaningful timeframe is desired.

References mentioned in this background section are not admitted to be prior art with respect to the present invention.

### SUMMARY

The present invention is directed to an automated environment whereby the value of individual sources or subsets of sources can be measured in terms of the actual impact on the underlying identity graph as well as direct comparisons between other sources. In certain implementations, a sandbox environment is created in which combinations of various candidate sources may be tested to determine the results. A person process, a person plus touchpoint process, and an activity value process may be executed as sub-components of the system. Results include whether a person (or person plus touchpoint) were added removed in the sandbox combination; whether a person (or person plus touchpoint) created a point of failure; and whether persons were consolidated or split as a result of the changes. The output of the environment provides an analysis of the evolution of an identity graph within an entity resolution system based on the choice of data sets used to build the graph.

These and other features, objects and advantages of the present invention will become better understood from a consideration of the following detailed description in conjunction with the drawings as described following:

### DRAWINGS

FIG. 1 is an overall process flow diagram for an embodiment of the invention.

FIG. 2 is a person process flow diagram for an embodiment of the invention.

FIG. 3 is a person plus touchpoint process flow diagram for an embodiment of the invention.

FIG. 4 is an activity value process flow diagram for an embodiment of the invention.

### DETAILED DESCRIPTION OF CERTAIN EMBODIMENTS

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

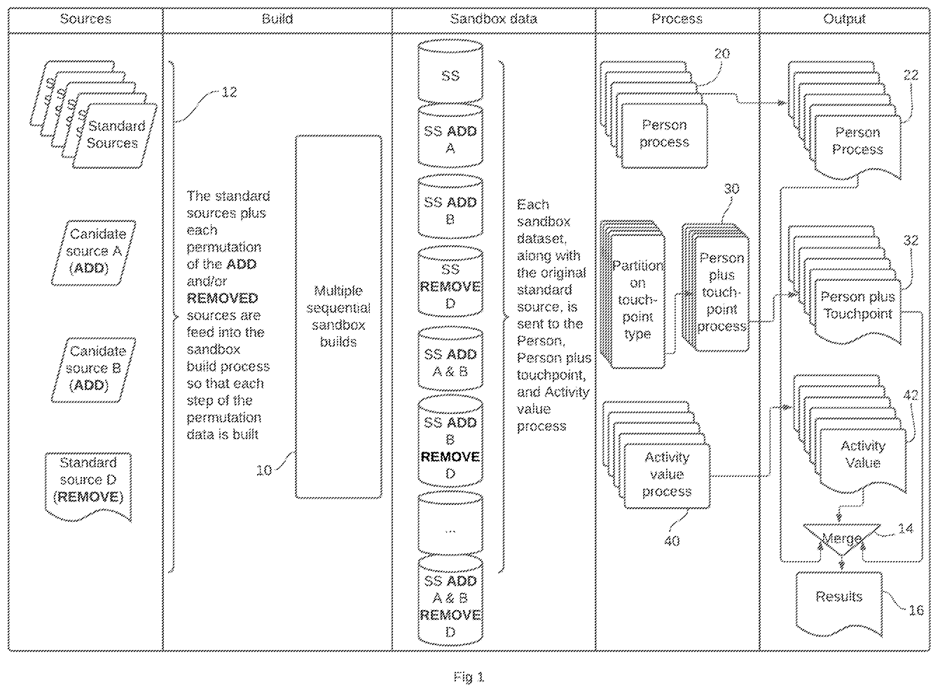

An embodiment of the invention may now be described with reference to the appended drawings, beginning with FIG. 1. The first component of the invention is the construction of “sandbox” test storage areas 10 to be used for the analysis of the specified data sources. If only one sandbox 10 is desired, the geolocation is identified. For example, if the data to be interpreted has coverage throughout the United States, the choice for the geolocation should strive to include as many normalized cultural, socioeconomic, and ethnic diversity primary patterns as the full US. In order to construct a dense subset of expected persons for the geolocation, the sandbox should contain all personally identifiable information (PII) records for each person that is included. The chosen persons are chosen from those that the data graph indicates has recent evidence that the person has strong associations with the geolocation. One type of association is a postal tie to the geolocation such as the household containing the person having an address within the geolocation. Another type is a digital one where at least one of the person's phone numbers has an area code associated with the geolocation and has evidence of recent use or activity. Once sandbox 10 is constructed, the associated resulting identity graph for this subset (resulting identity graph subset) is saved and represents the initial baseline from which a sequence of adjustments are made in terms of adding in or removing additional data files.

The next component is a process that takes as input an identity graph and the names of the data sources 12 to be added or removed. This process then uses the person formation process for the full identity graph to construct persons from the input graph with the input modifications. In the case of the addition of a set of data sources 12, all of the data is added to the sandbox 10. This is necessary as some of the new data may reflect different geolocational information for a person in the sandbox 10. In case of the removal of a set of data, those PII records that were contributed to the baseline graph by only this set will be removed from the sandbox 10.

Once the sandbox 10 data has been modified the same process to construct the full graph is used to form persons from the sandbox 10, creating a merged identity graph. Once persons are formed, persistent identifiers or links are computed for both the persons formed and the PII records by a modified process of the full graph linking process. Persistence in this context means that any PII record or person that did not change during the person formation process will continue to have the same identifier that was used in the baseline, any brand new PII record gets a new unique identifier as well as a newly formed person whose defining PII comes exclusively from new data. These identifiers may take any desired form, such as alphanumeric strings. In the case that input data graph persons are changed only by the introduction of new PII records, the baseline identifier is persisted. In the case that persons in the input data graph are merged together, a person in the graph breaks into multiple different persons, or persons in the graph lose some of their defining PII records, the assignment of the identifiers is made on minimizing the changes that will be visible when using the match service on a particular set of data. The process that accomplishes this requires the assessment of the recency and match requests for each of the involved PII records. For example, for the case that a person is split into different persons (because it is determined that data previously found to relate to one person actually pertains to multiple persons) the original person identifier is assigned to the new person whose data is most recent and has the most match hits for the defining PII records.

Once the new persons are formed and the identifiers are assigned in a persistent manner, this modified sandbox data graph is saved in sandbox 10. If additional modifications are needed (as described earlier) this identity graph can be used as input to this component in an iterative fashion.

The next component of the invention takes the set of all identity graphs constructed in the desired modification sequence and computes the differences between any pair of the data sets. The pairings of the consecutive data graphs relative to the linear ordering of the construction from the previous component is the default, but any pair of data graphs can be compared by this component. In the example of FIG. 1, there are two candidate sources A and B, and a removal candidate data source D. So various combinations are calculated in sandbox 10 for comparison with the existing graph, including the addition of data source A only; the addition of data source B only; only the removal of data source D; the addition of both data source A and data source B; the addition of data source B combined with the removal of data source D; the addition of both data source A and data source B combined with the removal of data source D; and so on to complete all possible combinations.

The differences computed to describe the evolutionary impact of the graph express the fundamental changes of the graph due to the modification. One such change is the creation of new persons from new data (occurs only if new data is added). This difference indicates that some of the data provided by the newly added sources is distinctly different than that present in the input data graph. However, as the input data graph is restricted to a specific geolocation, only those new persons who have postal, digital, or other touchpoint instances that directly tie them to this geolocation is meaningful. A second change is the complete deletion of all of the existing PII records for a person in the input data graph. This can happen when the modification is the removal of a set of data sources, and if it does occur each instance is meaningful relative to the evolution of the input data graph. Continuing, one or more persons in the input data graph can combine into a single person either with the deletion or addition of data sources. This behavior (a consolidation) is meaningful to the evolution of the input data graph as no matter how the consolidation occurred the impact is on persons in the original input graph. The same is true for splits, that is, the breaking of a single person into two or more different persons.

To this point the stated differences have been in regards to the actual person formations, but an additional general evolutionary effect that is captured is in terms of whether the actual PII records and corresponding persons have confirmatory data sources. Every PII record that has only one contributing source is a “point of failure” record in the data graph as the removal of that contributing source can cause a significant change in the data graph as already noted. Hence when a set of data sources is removed from the data graph it is important to identify those PII records which did not disappear but rather became such “point of failure” records. Moving from the level of PII records to a person level (i.e., disjoint sets of PII records), if the deletion of a set of data sources creates a person such that every defining PII record for that person is a “point of failure” record then the person becomes a “point of failure” person. This notion of “point of failure” person must be extended to cases where not every defining PII record is a “point of failure” record. This happens when all of the records that contain the PII that many, if not all, of the users or clients of the entity resolution system have as their definition of that person. The future removal of those records will not allow the client to access or find that person even though the person may still exist in the data graph. For example, person P1 has three PII records that have multiple data sources confirming the represented PII and one PII record that is a “point of failure”. All of the clients that get this person as a result of the match service do so only by the PII in the “point of failure” record. The loss of the record will keep the person but none of the clients will be able to access the person through the remaining three PII records.

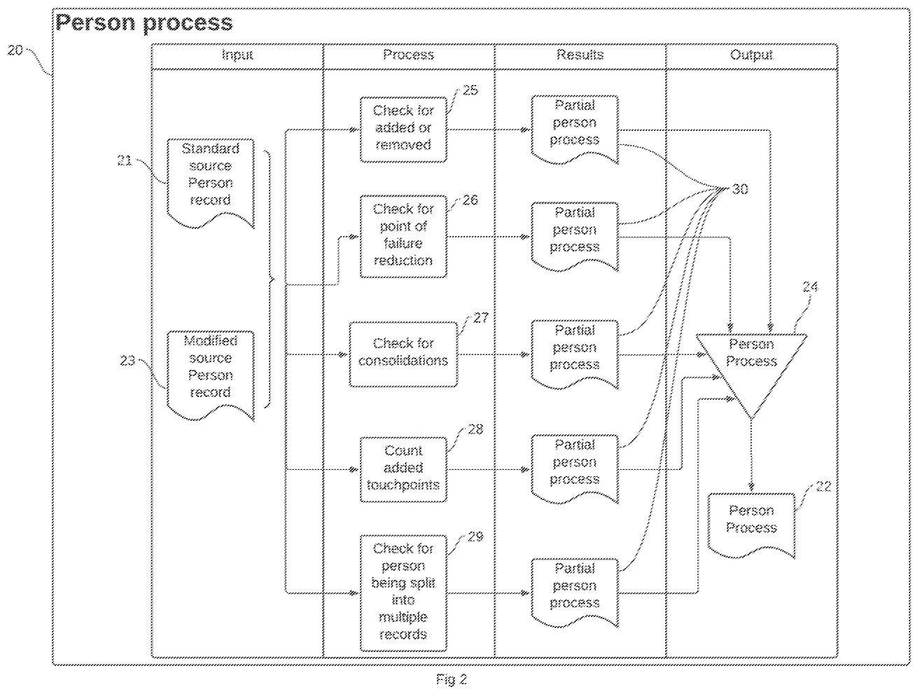

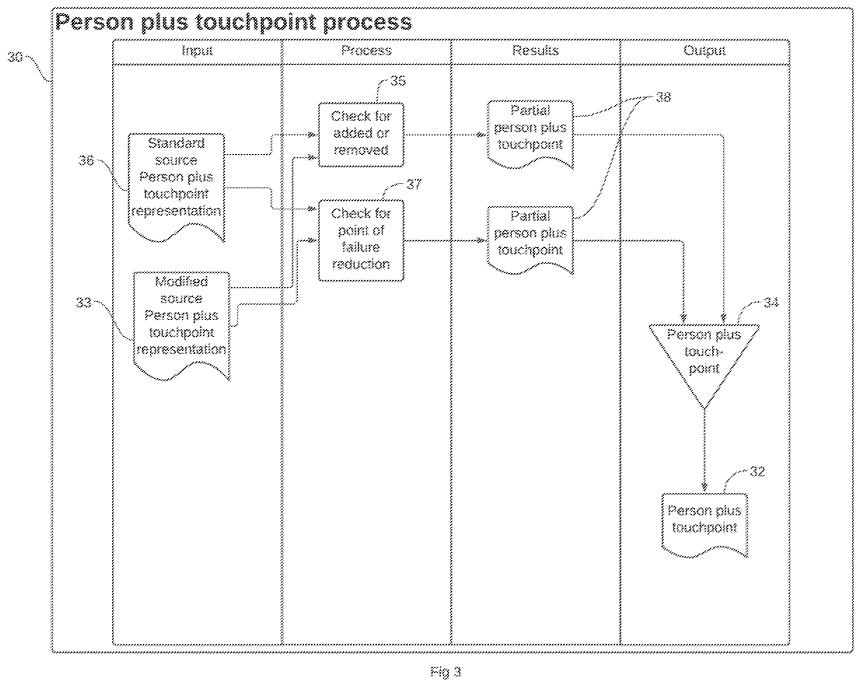

FIG. 2 illustrates person process 20 as just described. Using standard source person record 21 and modified person source record 23, the various processes applied are to check for the person being added or removed at step 25, check for a point of failure reduction at step 26, check for consolidations at step 27, count added touchpoints at step 28, and check for the person being split into multiple records at step 29. The partial results from each of these steps at partial person process results 31 are merged at person process merge 24 to create person process results 22. FIG. 3 similarly illustrates the person plus touchpoint process 30. Using standard source person plus touchpoint record 36 and modified source person plus touchpoint record 33, the various processes applied are to check for added or removed person plus touchpoint at step 35 and check for point of failure reduction at step 37. The partial results from these two steps at partial person plus touchpoint process results 38 are merged at person plus touchpoint process merge 34 to create person plus touchpoint process results 32.

Next, the process splits the computed data into two sets. The first (and primary) set is the differences that include persons who are most sought after for a particular purpose, referred to herein as “active” persons. The second category is the complement of the first, referred to herein as “inactive” persons. The notion of “active” is often primarily based on the residual logs of the entity resolution system's match service, which provides information about what person was returned from the match service and the specific PII record that produced the actual match. Although the clients' input is not logged, this information gives a clear signal as to what PII in the identity graph is responsible for each successful match. There are different perspectives of a definition of an “active” person, and in many contexts there is a desire to have a sequence of definitions that measures different degrees or types of activeness. The invention in various embodiments allows for any such user defined sequence that uses data available to the system. However, at least one of the chosen definitions to be used involves a temporal interpretation of the clients' use of the resolution system's match service.

To compute the set of active persons a most recent temporal window is chosen, in some embodiments with width at least six months. This width is computed based on the historical use patterns of most of the system's clients. For example, if most clients use the match service between monthly and quarterly, a six-month window will generate a very representative signal of usage. Otherwise a larger window, such as twelve months, could be used. Using the temporal signal of clients' match logged values, a count of the number of job units per client for each PII record is the basis for the match. A job unit is either a single batch job from a single client or the set of transactional match calls by a common client that are temporally dense (appear within a well-defined start time and end time). A single PII record can be “hit” by the match service multiple times within a job unit and this can cause the interpretation of the counts to be artificially skewed. Hence for each job unit for each client a “hit” PII record will be counted only once. In the case that the notion of “active” is wished to be defined in different ways for different types of clients (such as financial institutions or retail businesses) the resulting signal is decomposed into the appropriate number of sub-signals.

For each sub-signal one interpretation of “active” persons is represented in terms of several patterns of the temporal signal from a match service results log. These patterns can include, and are not limited to, the relative recency of a large proportion of the non-zero counts; whether the signal is increasing or decreasing from the farthest past time to the present; and the amount of fluctuation from month to month (first order differences). For example, when a person makes a change in postal address or telephone number, these changes are almost never propagated to all of the person's financial and retail accounts at the same time. Often it takes months (if ever) for the change to get to all of those accounts. In these cases, this new PII will slowly begin to be seen in the signal with very small counts, but as time goes by, this signal will exhibit a clear pattern of increasing counts. The magnitude of the counts can be ignored as it is this increasing counts behavior that clearly indicates this new PII is important to the clients of the resolution system. Similarly, some companies purchase “prospecting” files of potential new customers, and those are often run though the system's match service to see if any of the persons in the file are already customers. As such prospecting files are not run at a steady cadence these instances can be identified in the signal by multiple fluctuations whose differences are of a much greater magnitude than the usual and expected perturbations. This type of signal may not indicate known client (customer) interest and hence often are not considered as “active” persons.

Once the active persons are identified, the previously computed identity graph to identity graph differences are separated into those that involve at least one active person and those that contain no active person. The evolutionary impact of the differences within this latter set has significantly less probability of changing the system's data graph in a way that would impact the system's clients than the former. Hence the splitting of the differences helps the interpretation of the results to weigh the overall impact in a more expressive and defensible manner.

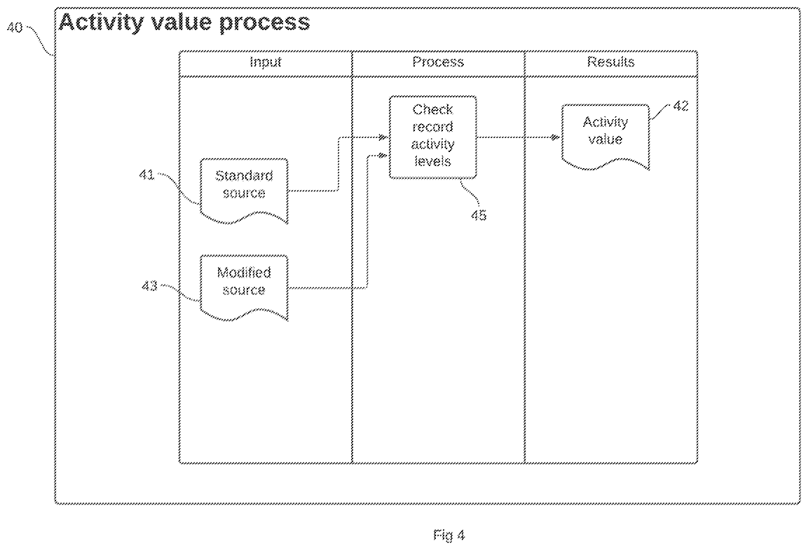

FIG. 4 provides an overview of this activity value process 40. Standard source 41 and modified source 43 are used as inputs to the check record activity counts process 45. The activity value results 42 is the output of this sub-process. Now, as shown in FIG. 1, the person process results 22, person plus touchpoint results 32, and activity value results 42 may be combined at merge step 14, to produce overall results 16 for the entire process.

The overall results 16 provides the counts of each noted type of difference, and for each two or more counts are presented. The following is the example result of a removal of a single data source from the sandbox 10 initial data graph:
[5404267, [2571398, 306, 15], [3799, 311, 151], [190771, 23105, 20310], [209069, 19, 2]]
   The first value indicates that there were a total of 5.4 M PII records removed as they were contributed only by this one source. The next three-tuple represents the differences in terms of persons losing some but not all of their PII records.
   The first value (2.57 M) indicates the total number of persons in the sandbox data graph for which this occurred. The next two values represent the counts for two different definitions of “active” persons, the first less restrictive than the second. Continuing, the next three-tuple represents the same kind of counts for those persons who lost all of their PII records, followed by the three-tuple for those persons who split into two or more persons, and finally the three-tuple for those persons who were consolidated with another person. It should be noted that the effect of consolidation seems odd when data is removed, and this case is often overlooked. But a PII record for a person can be the critical one that separates two or more strongly related subsets of PII records, and its removal loses enough context to continue to split the subsets.

These steps interpret a single set of source files as a unit and independently from other sets of interest. (One can infer some relationships between multiple sets of source files by purposely sequencing the sets and analyzing the different permutations of iteratively passing the same sets through the described process, as will be described below.) Quite often the use context starts with a (large) set of source files and the question to answer is what subset of the full set is a “good” subset to either add to or remove from the entity resolution identity graph that enhances and/or minimizes the negative impact on the resulting resolution. From this larger perspective rather than the direct impact on the person formations, the intent is to determine impact on the resolution capabilities for each person in terms of the presented touchpoint instances that define the person, i.e. postal addresses, email addresses, and phone numbers. A person may have multiple PII records that are contributed by many data sources, but if there are no specific touchpoint type instances (no phone numbers, no emails, etc.) then the capability of users of the resolution system to access that person through the match service using that touchpoint type.

In another variation, the invention addresses the issue of the “point of failure” not in terms of the specific PII records but rather in terms of minimal subsets of source files whose removal will remove all of a specified touchpoint type instances for a person. The following will use email addresses to describe the process, but is also applied to other touchpoint types such as phone numbers, postal addresses, IP addresses, etc. A source file (rather than a person in the identity graph) is a “point of failure” if the removal of all of the PII records for which this file is the only contributor from the data graph creates a person who had email addresses prior to the removal but has no email addresses after the removal. The removal of a source file often removes some email addresses for persons, and the removal of such email addresses are not necessarily detrimental to either the evolution of the data graph or the present state of the clients' experience with the match service. In fact, historically, early provided email addresses contained a large amount of “generated” or bogus email addresses that no client has ever used as PII for their customers. The removal of such email addresses can cause a significant improvement in the person formations in the data graph. However, the removal of all of the email addresses for a person has a much higher probability of a negative impact on the graph and users' experience with the match service.

The notion of data source “point of failure” extends to not only a single source file but subsets of source files. Hence in various embodiments the invention computes the number of persons in the input identity graph that loses all of its email addresses. The input into this component is the input graph as defined above and the set of data sources whose PII records are to be considered for potential removal from the identity graph. Each element of the set of data sources can be either a single data source or a set of data sources (either all stay in the graph or all must be removed, hence treated as one).

As noted earlier, both the client and evolutionary impact of any loss of information should be considered relative to the notion of “active” persons defined earlier. Once again, this invention allows for any sequence of definitions of degrees of “activeness”. The input is the input identity graph as defined earlier, the set of touchpoint types to be considered in the analysis, the sequence of definitions of “active” persons, and the set of source files considered for potential removal from the data graph. The following describes the type of computations as well as the output:
1. For each input touchpoint type:
   1.a. For each combination of subsets of sources:
      the counts of persons in the input data graph that lost all of their input touchpoint type instances due to the removal of the combination but not to any smaller subset of the combination are computed for all persons as well as for those persons included in each of the input definitions of “active” persons; and
2. The possible output result data formats include grouping based on all combinations containing a single source file entry in the input as well as sorted lists based on the counts.

The results from these two major components (“person” based differences and “source” based differences) provide a multi-dimensional expressive view of the major areas of impact for proposed changes in the basic data that forms the resolution system's identity graph. Often, very narrow views drive such proposals such as an increase in the number of email and other digital touchpoints for greater coverage relative to the match service. However, each expected improvement comes at a cost in terms of some degree of negative impact. The decisions to make such changes have greatly varied parameters and contexts that define the notion of overall value and improvement. Hence this invention is designed to provide an expressive summary of these two important dimensions of the evolution of the data graph.

The systems and methods described herein may in various embodiments be implemented by any combination of hardware and software. For example, in one embodiment, the systems and methods may be implemented by a computer system or a collection of computer systems, each of which includes one or more processors executing program instructions stored on a computer-readable storage medium coupled to the processors. The program instructions may implement the functionality described herein. The various systems and methods as illustrated in the figures and described herein represent example implementations. The order of steps in the methods may be changed, and various elements may be added, modified, or omitted to the systems.

A computing system or computing device as described herein may be implemented using a hardware portion of a cloud computing system or non-cloud computing system. The computer system may be any of various types of devices, including, but not limited to, a commodity server, personal computer system, desktop computer, laptop or notebook computer, mainframe computer system, handheld computer, workstation, network computer, a consumer device, application server, storage device, mobile telephone, or in general any type of computing node or device. The computing system includes one or more processors (any of which may include multiple processing cores, which may be single or multi-threaded) coupled to a system memory via an input/output (I/O) interface. The computer system further may include a network interface coupled to the I/O interface.

In various embodiments, the computer system may be a single processor system including one processor, or a multiprocessor system including multiple processors. The processors may be any suitable processors capable of executing computing instructions. For example, in various embodiments, they may be general-purpose or embedded processors implementing any of a variety of instruction set architectures. In multiprocessor systems, each of the processors may commonly, but not necessarily, implement the same instruction set. The computer system also includes one or more network communication devices (e.g., a network interface) for communicating with other systems and/or components over a communications network, such as a local area network, wide area network, or the Internet. For example, a client application executing on the computing device may use a network interface to communicate with a server application executing on a single server or on a cluster of servers that implement one or more of the components of the systems described herein in a cloud computing or non-cloud computing environment as implemented in various sub-systems. In another example, an instance of a server application executing on a computer system may use a network interface to communicate with other instances of an application that may be implemented on other computer systems.

The computing device also includes one or more persistent storage devices and/or one or more I/O devices. In various embodiments, the persistent storage devices may correspond to disk drives, tape drives, solid state memory, other mass storage devices, or any other persistent storage devices. The computer system (or a distributed application or operating system operating thereon) may store instructions and/or data in persistent storage devices, as desired, and may retrieve the stored instruction and/or data as needed. For example, in some embodiments, the persistent storage may include the solid-state drives attached to that server node. Multiple computer systems may share the same persistent storage devices or may share a pool of persistent storage devices, with the devices in the pool representing the same or different storage technologies.

The computer system includes one or more system memories that may store code/instructions and data accessible by the processor(s). The system memories may include multiple levels of memory and memory caches in a system designed to swap information in memories based on access speed, for example. The interleaving and swapping may extend to persistent storage in a virtual memory implementation. The technologies used to implement the memories may include, by way of example, static random-access memory (RAM), dynamic RAM, read-only memory (ROM), non-volatile memory, or flash-type memory. As with persistent storage, multiple computer systems may share the same system memories or may share a pool of system memories. System memory or memories may contain program instructions that are executable by the processor(s) to implement the routines described herein. In various embodiments, program instructions may be encoded in binary, Assembly language, any interpreted language such as Java, compiled languages such as C/C++, or in any combination thereof; the particular languages given here are only examples. In some embodiments, program instructions may implement multiple separate clients, server nodes, and/or other components.

In some implementations, program instructions may include instructions executable to implement an operating system, which may be any of various operating systems, such as UNIX, LINUX, MacOS™, or Microsoft Windows™. Any or all of program instructions may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software) readable by a machine (e.g., a computer). Generally speaking, a non-transitory computer-accessible medium may include computer-readable storage media or memory media such as magnetic or optical media, e.g., disk or DVD/CD-ROM coupled to the computer system via the I/O interface. A non-transitory computer-readable storage medium may also include any volatile or non-volatile media such as RAM or ROM that may be included in some embodiments of the computer system as system memory or another type of memory. In other implementations, program instructions may be communicated using optical, acoustical or other form of propagated signal (e.g., carrier waves, infrared signals, digital signals, etc.) conveyed via a communication medium such as a network and/or a wired or wireless link, such as may be implemented via a network interface. A network interface may be used to interface with other devices, which may include other computer systems or any type of external electronic device. In general, system memory, persistent storage, and/or remote storage accessible on other devices through a network may store data blocks, replicas of data blocks, metadata associated with data blocks and/or their state, database configuration information, and/or any other information usable in implementing the routines described herein.

In certain implementations, the I/O interface may coordinate I/O traffic between processors, system memory, and any peripheral devices in the system, including through a network interface or other peripheral interfaces. In some embodiments, the I/O interface may perform any necessary protocol, timing or other data transformations to convert data signals from one component (e.g., system memory) into a format suitable for use by another component (e.g., processors). In some embodiments, the I/O interface may include support for devices attached through various types of peripheral buses, such as a variant of the Peripheral Component Interconnect (PCI) bus standard or the Universal Serial Bus (USB) standard, for example. Also, in some embodiments, some or all of the functionality of the I/O interface, such as an interface to system memory, may be incorporated directly into the processor(s).

A network interface may allow data to be exchanged between a computer system and other devices attached to a network, such as other computer systems (which may implement one or more storage system server nodes, primary nodes, read-only node nodes, and/or clients of the database systems described herein), for example. In addition, the I/O interface may allow communication between the computer system and various I/O devices and/or remote storage. Input/output devices may, in some embodiments, include one or more display terminals, keyboards, keypads, touchpads, scanning devices, voice or optical recognition devices, or any other devices suitable for entering or retrieving data by one or more computer systems. These may connect directly to a particular computer system or generally connect to multiple computer systems in a cloud computing environment or other system involving multiple computer systems. Multiple input/output devices may be present in communication with the computer system or may be distributed on various nodes of a distributed system that includes the computer system. The user interfaces described herein may be visible to a user using various types of display screen technologies. In some implementations, the inputs may be received through the displays using touchscreen technologies, and in other implementations the inputs may be received through a keyboard, mouse, touchpad, or other input technologies, or any combination of these technologies.

In some embodiments, similar input/output devices may be separate from the computer system and may interact with one or more nodes of a distributed system that includes the computer system through a wired or wireless connection, such as over a network interface. The network interface may commonly support one or more wireless networking protocols (e.g., Wi-Fi/IEEE 802.11, or another wireless networking standard). The network interface may support communication via any suitable wired or wireless general data networks, such as other types of Ethernet networks, for example. Additionally, the network interface may support communication via telecommunications/telephony networks such as analog voice networks or digital fiber communications networks, via storage area networks such as Fibre Channel storage area networks (SANs), or via any other suitable type of network and/or protocol.

Any of the distributed system embodiments described herein, or any of their components, may be implemented as one or more network-based services in the cloud computing environment. For example, a read-write node and/or read-only nodes within the database tier of a database system may present database services and/or other types of data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format, such as the Web Services Description Language (WSDL). Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP). In some embodiments, network-based services may be implemented using Representational State Transfer (REST) techniques rather than message-based techniques. For example, a network-based service implemented according to a REST technique may be invoked through parameters included within an HTTP method such as PUT, GET, or DELETE.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a grouping is used herein, all individual members of the group and all combinations and sub-combinations possible of the group are intended to be individually included in the disclosure. When a range is stated herein, all sub-ranges within the range and all distinct points within the range are intended to be individually included in the disclosure. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A system for performing evolutionary analysis of a data structure, the system comprising:
an identity graph stored on one or more storage devices;
a sandbox stored on the one or more storage devices; and one or more processors in communication with the one or more storage devices, wherein the one or more storage devices has instructions stored thereon which, when executed by the one or more processors, cause the one or more processors to perform actions including:
create a subset of the identity graph, wherein the identity graph subset consists only of records pertaining to at least one geolocation, and storing the identity graph subset in the sandbox;
add to the sandbox at least one candidate data source;
combine the identity graph subset and the at least one candidate data source to produce at least one modified sandbox data graph; and
output a results set identifying changes to person records between the identity graph subset and the modified sandbox data graph.

2. The system of claim 1, wherein the identity graph subset consists only of records for persons with a postal tie to the geolocation.

3. The system of claim 2, wherein the identity graph subset consists only of records for persons who are members of a household in the geolocation.

4. The system of claim 1, wherein the identity graph subset consists only of records for persons having a phone number with an area code corresponding to the geolocation.

5. The system of claim 1, wherein the identity graph subset further consists only of records for persons having recent activity on the phone number with the area code corresponding to the geolocation.

6. The system of claim 1, wherein the at least one candidate data source comprises data to be removed from the identity graph subset.

7. The system of claim 1, wherein the at least one candidate data source comprises data to be added to the identity graph subset.

8. The system of claim 1, wherein the one or more storage devices has further instructions stored thereon which, when executed by the one or more processors, cause the one or more processors to compute identifiers for persons in the at least one modified sandbox data graph.

9. The system of claim 8, wherein the identifiers for persons in the at least one merged identity graph comprise new identifiers for persons present in the at least one modified sandbox data graph but not in the identity graph subset.

10. The system of claim 8, wherein the identifiers for persons in the at least one modified sandbox data graph comprise consolidated identifiers for persons merged in the at least one modified sandbox data graph but who were separate in the identity graph subset.

11. The system of claim 1, wherein the at least one modified sandbox data graph comprises a plurality of modified sandbox data graphs.

12. The system of claim 11, wherein the at least one data sets comprises a plurality of data sets, and the plurality of modified sandbox data graphs comprises a modified sandbox data graph corresponding to each possible combination of one of the plurality of data sets with the identity graph subset.

13. The system of claim 1, wherein the one or more storage devices has further instructions stored thereon which, when executed by the one or more processors, cause the one or more processors to combine the identity graph subset and the at least one candidate data source to produce at least one modified sandbox data graph by performing a person process on the identity graph subset.

14. The system of claim 13, wherein the person process comprises checking for added or removed persons.

15. The system of claim 14, wherein the person process comprises checking for person point of failure reduction.

16. The system of claim 15, wherein the person process comprises checking for consolidations.

17. The system of claim 16, wherein the person process comprises a process to count added touchpoints.

18. The system of claim 17, wherein the person process comprises a process to check for split records.

19. The system of claim 1, wherein the one or more storage devices has further instructions stored thereon which, when executed by the one or more processors, cause the one or more processors to combine the identity graph subset and the at least one candidate data source to produce at least one modified sandbox data graph by performing a person plus touchpoint process on the identity graph subset.

20. The system of claim 19, wherein the person plus touchpoint process comprises checking for added or removed persons plus touchpoints.

21. The system of claim 20, wherein the person plus touchpoint process comprises checking for person plus touchpoint point of failure reduction.

22. The system of claim 1, wherein the one or more storage devices has further instructions stored thereon which, when executed by the one or more processors, cause the one or more processors to combine the identity graph subset and the at least one candidate data source to produce at least one modified sandbox data graph by performing an activity process on the identity graph subset to identify active persons.

23. A method for performing evolutionary analysis on a data structure, the method comprising:
create a subset of an identity graph comprising a plurality of records wherein each of the plurality of records comprises a plurality of touchpoints pertaining to a person, wherein the identity graph subset consists only of records pertaining to persons corresponding to at least one geolocation;
storing the identity graph subset in a sandbox test storage area;
adding to the sandbox at least one candidate data source, wherein the at least one candidate data source comprises a plurality of records comprising a plurality of touchpoints pertaining to a person;
combining the identity graph subset and the at least one candidate data source to produce at least one modified sandbox data graph; and
outputting a results set identifying changes to person records between the identity graph subset and the modified sandbox data graph.

24. The method of claim 23, wherein the at least one candidate data source comprises data to be removed from the identity graph subset.

25. The method of claim 23, wherein the at least one candidate data source comprises data to be added to the identity graph subset.

26. The method of claim 23, further comprising the step of computing identifiers for persons in the at least one modified sandbox data graph.

27. The method of claim 26, wherein the identifiers for persons in the at least one merged identity graph comprise new identifiers for persons present in the at least one modified sandbox data graph but not in the identity graph subset.

28. The method of claim 26, wherein the identifiers for persons in the at least one modified sandbox data graph comprise consolidated identifiers for persons merged in the at least one modified sandbox data graph but who were separate in the identity graph subset.

29. The method of claim 23, wherein the at least one modified sandbox data graph comprises a plurality of modified sandbox data graphs, the at least one data sets comprises a plurality of data sets, and the plurality of modified sandbox data graphs comprises a modified sandbox data graph corresponding to each possible combination of one of the plurality of data sets with the identity graph subset.

30. The method of claim 23, wherein the step of outputting a results set identifying changes to person records between the identity graph subset and the modified sandbox data graph comprises the step of performing a person process on the modified sandbox data graph, wherein the person process comprises checking for added or removed persons, checking for point of failure reduction among the persons, checking for consolidations among the persons, counting added touchpoints among the persons, or checking for persons being split into multiple persons, or any combination thereof.

31. The method of claim 30, wherein the step of outputting a results set identifying changes to person records between the identity graph subset and the modified sandbox data graph comprises the step of performing a person plus touchpoint process on the modified sandbox data graph, wherein the person plus touchpoint process comprises checking for added or removed persons, checking for point of failure reduction among the persons, or any combination thereof.

32. The method of claim 31, wherein the step of outputting a results set identifying changes to person records between the identity graph subset and the modified sandbox data graph comprises the step of performing an activity process on the modified sandbox data graph, wherein the activity process comprises identifying active persons in the modified sandbox data graph.
